(19) United States
(12) Patent Application Publication
(10) Pub. No.: US 2015/0085352 A1
(43) Pub. Date: Mar. 26, 2015

(54) OPTICAL AMPLIFIER FOR SPACE-DIVISION MULTIPLEXING

(71) Applicant: Alcatel-Lucent USA Inc., Murray Hill, NJ (US)

(72) Inventors: Roland Ryf, Aberdeen, NJ (US); Nicolas K. Fontaine, Keyport, NJ (US); Rene-Jean Essiambre, Red Bank, NJ (US); David Neilson, Old Bridge, NJ (US)

(73) Assignee: ALCATEL-LUCENT USA INC., Murray Hill, NJ (US)

(21) Appl. No.: 14/032,299

(22) Filed: Sep. 20, 2013

(51) Int. Cl. H01S 3/067; H01S 3/094

(52) U.S. Cl. CPC H01S 3/06754; H01S 3/094007
USPC 359/341.33; 359/341.1

(57) ABSTRACT

In an example embodiment, an optical amplifier comprises a doped multi-core optical fiber and two optical couplers placed at the ends of the doped multi-core fiber, with each optical coupler having a respective plurality of optical waveguide cores optically coupled to the optical waveguide cores of the doped multi-core fiber. The spatial arrangement of the cores at the input end of the first optical coupler is configured for low-loss intake of the optical energy from the input transmission line. The spatial arrangement of the cores at the output end of the first optical coupler and the spatial arrangement of the cores at the input end of the second optical coupler match the spatial arrangement of the cores in the doped multi-core fiber. The spatial arrangement of the cores at the output end of the second optical coupler is configured for low-loss transfer of the optical energy into the output transmission line.

### BACKGROUND

1. Field

The present invention relates to optical communication equipment and, more specifically but not exclusively, to optical amplifiers.

2. Description of the Related Art

This section introduces aspects that may help facilitate a better understanding of the invention(s). Accordingly, the statements of this section are to be read in this light and are not to be understood as admissions about what is in the prior art or what is not in the prior art.

An optical amplifier is a device that amplifies an optical signal directly in the optical domain without converting the optical signal into a corresponding electrical signal. Optical amplifiers are widely used, for example, in the fields of optical communications and laser physics.

One type of an optical amplifier is a doped-fiber amplifier, with a well-known example being the Erbium-doped fiber amplifier (EDFA). In operation, a signal to be amplified and a pump beam are applied to the doped fiber. The pump beam excites the doping ions, and amplification of the signal is achieved by stimulated emission of photons from the excited dopant ions.

Another type of an optical amplifier is a Raman amplifier, which relies on stimulated Raman scattering (SRS) for signal amplification. More specifically, when a signal to be amplified and a pump beam are applied to an optical fiber made of an appropriate material, a lower-frequency signal photon induces SRS of a higher-frequency pump photon, which causes the pump photon to pass some of its energy to the vibrational states of the fiber material, thereby converting the pump photon into an additional signal photon. The pump beam may be coupled into the fiber in the same direction as the signal (co-directional pumping) or in the opposite direction (contra-directional pumping).

### SUMMARY OF SOME SPECIFIC EMBODIMENTS

Disclosed herein are various embodiments of an optical amplifier, e.g., suitable for amplifying space-division multiplexed signals received from an optical fiber transmission line. In an example embodiment, the optical amplifier comprises a doped multi-core optical fiber configured to receive an optical pump beam in a manner that causes the optical pump energy to be transferred into the optical waveguide cores of the doped multi-core optical fiber while being guided along the length of the multi-core optical fiber. The optical amplifier further comprises two optical couplers placed at the ends of the doped multi-core fiber, with each optical coupler having a respective plurality of optical waveguide cores optically coupled to the optical waveguide cores of the doped multi-core optical fiber. The spatial arrangement of the optical waveguide cores at the input end of the first optical coupler may be configured for low-loss intake of the optical energy from an input fiber optical transmission line. The spatial arrangement of the optical waveguide cores at the output end of the first optical coupler and the spatial arrangement of the optical waveguide cores at the input end of the second optical coupler match the spatial arrangement of the optical waveguide cores in the doped multi-core fiber. The spatial arrangement of the optical waveguide cores at the output end of the second optical coupler may be configured for low-loss transfer of the optical energy into an output fiber optical transmission line. In various embodiments, each of the input and output fiber optical transmission lines can be selected from a set including a multimode optical fiber, a multi-core optical fiber, and a fiber-optic cable. The doped multi-core optical fiber can be configured to amplify optical signals via a stimulated-emission process or a stimulated Raman-scattering process.

According to one embodiment, provided is an apparatus comprising: a first rare-earth doped multi-core optical fiber having a first plurality of optical waveguide cores, each optical waveguide core configured to guide and amplify a respective portion of optical power received through an input end thereof to generate a respective amplified light signal at an output end thereof; a first three-dimensional optical waveguide device configured to end-couple an input optical fiber transmission line to the input end of the first rare-earth doped multi-core optical fiber; and a second three-dimensional optical waveguide device configured to end-couple light from the output end of the first rare-earth doped multi-core optical fiber into an output optical fiber transmission line.

According to another embodiment, provided is an apparatus comprising: an input port configured to end-connect to a first optical fiber transmission line; an output port configured to end-connect to a second optical fiber transmission line; a first doped multi-core optical fiber having a first plurality of optical waveguide cores, each configured to amplify, using a first optical pump beam, a respective portion of optical power received through the input port to generate a respective amplified portion of the optical power, wherein the first doped multi-core optical fiber is configured to direct the amplified portions of the optical power generated by different ones of the first plurality of optical waveguide cores toward the output port; and a first optical coupler coupled between the input port and the first doped multi-core optical fiber. The first optical coupler comprises a second plurality of optical waveguide cores, each configured to guide the respective portion of the optical power received through the input port toward the respective one of the first plurality of optical waveguide cores. A spatial arrangement of the second plurality of optical waveguide cores at an input end of the first optical coupler is different from a spatial arrangement of the second plurality of optical waveguide cores at an output end of the first optical coupler.

According to yet another embodiment, provided is an apparatus comprising: an input port configured to end-connect to a first optical transmission line; an output port configured to end-connect to a second optical transmission line; a first doped multi-core optical fiber having a first plurality of cores, each configured to amplify, using a first optical pump beam, a respective portion of optical power received through the input port to generate a respective amplified portion of the optical power, wherein the first doped multi-core optical fiber is configured to direct the amplified portions of the optical power generated by different ones of the first plurality of cores toward the output port; and a first optical coupler coupled between the first doped multi-core optical fiber and the output port. The first optical coupler comprises a second plurality of cores, each configured to guide the respective one of the amplified portions of the optical power generated by different ones of the first plurality of cores toward the output port. A spatial arrangement of the second plurality of cores at an input end of the first optical coupler is different from a spatial arrangement of the second plurality of cores at an output end of the first optical coupler.

### BRIEF DESCRIPTION OF THE DRAWINGS

Other aspects, features, and benefits of various embodiments of the invention will become more fully apparent, by way of example, from the following detailed description and the accompanying drawings, in which:

FIG. 1 shows a block diagram of an optical amplifier according to an embodiment of the disclosure;

FIG. 2 shows a cross-sectional view of a multi-core optical fiber that can be used in the optical amplifier of FIG. 1 according to an embodiment of the disclosure;

FIGS. 3A-3C show a three-dimensional optical waveguide device that may form the optical end-couplers used in the optical amplifier of FIG. 1 according to an embodiment of the disclosure;

FIG. 4 shows a block diagram of an optical amplifier according to another embodiment of the disclosure; and

FIG. 5 shows a block diagram of a gain-equalizing filter that can be used in the optical amplifier of FIG. 4 according to an embodiment of the disclosure.

### DETAILED DESCRIPTION OF ILLUSTRATIVE EMBODIMENTS

Some embodiments disclosed herein may benefit from the subject matter of U.S. patent application Ser. No. 1______/______,______, filed on the same date as the present application, by Roland Ryf, Nicolas Fontaine, and David Neilson, attorney docket reference 814846-US-NP, entitled “COMPACT TWO-STAGE OPTICAL AMPLIFIER,” which is incorporated herein by reference in its entirety.

Herein, a three-dimensional optical waveguide device has multiple optical waveguide cores embedded in an optical cladding and connecting first and second faces of the device. In such a device, the lateral spatial arrangement of, at least, two of the optical waveguide cores varies between the first and second faces.

A multimode or multi-core optical fiber can provide a higher transmission capacity than a single-mode fiber by means of space-division multiplexing (SDM), wherein different spatial modes of the multimode or multi-core optical fiber are populated with different modulated optical signals or different combinations of a given set of modulated optical signals. Long-distance transport of SDM signals over multimode and/or multi-core optical fibers can greatly benefit from the use of optical amplifiers that enable the optical gain for each spatial and/or wavelength channel to be individually controlled and/or adjusted, e.g., to ensure that the corresponding optical-transport link has favorable signal-transport characteristics.

For example, different spatial modes of a multimode fiber (e.g., LP modes in a weakly guiding cylindrical fiber or waveguide) are generally subjected to different degrees of attenuation over the same fiber length, with the higher-order modes typically being subjected to stronger attenuation than the lower-order modes. However, a desired characteristic of an optical-transport link is often about a 0-dB net gain for all populated spatial modes. This dB number implies that it is often beneficial when signal attenuation in the optical-transport link is substantially canceled or compensated to a significant degree by signal amplification in the corresponding optical amplifier(s) at the proximal and/or distal end of the optical-transport link.

Some features of spatial mode multiplexing in multimode and multi-core optical fibers are described, e.g., in U.S. Patent Application Publication No. 2013/0070330 and U.S. Pat. No. 8,320,769, both of which are incorporated herein by reference in their entirety.

Some of the above-mentioned and other pertinent problems in the art may be addressed by some of the embodiments of an optical amplifier, which are disclosed herein. In one embodiment, such an optical amplifier can be used, e.g., to amplify SDM optical signals, which are transported through a multimode or multi-core optical fiber before and/or after optical amplification in the optical amplifier. In various embodiments, such an optical amplifier can be configured to amplify optical signals via a stimulated-emission process or a stimulated Raman-scattering (SRS) process. Advantageously, some embodiments of the optical amplifier disclosed herein may provide a cost-effective solution for long-distance optical transport of SDM signals.

Some embodiments of an optical amplifier disclosed herein can also be adapted for amplifying optical signals transported by a fiber-optic cable comprising a plurality of bundled single-mode or multimode fibers, e.g., using an amplifier design conceptually similar to that used for multi-core optical fibers.

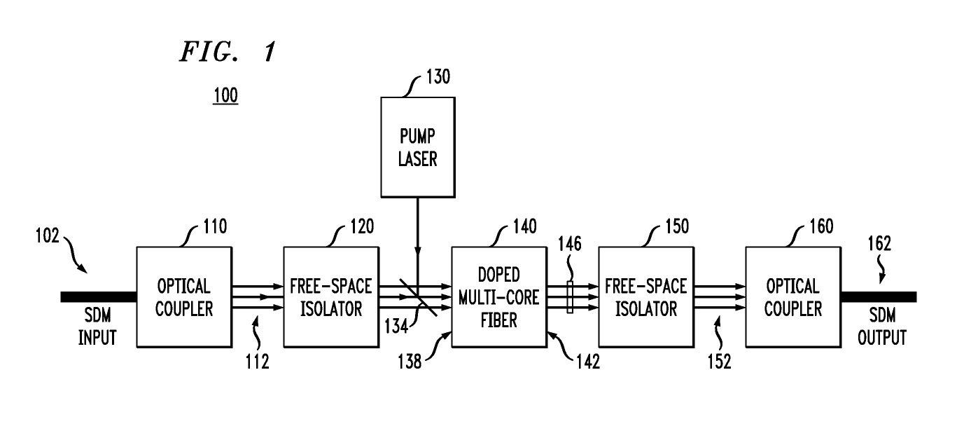

FIG. 1 shows a block diagram of an optical amplifier 100 according to an embodiment of the disclosure. Optical amplifier 100 has an SDM input port 102 and an SDM output port 162, each of SDM ports 102, 162 being configured to be connected to a respective optical fiber SDM transmission line. In various embodiments, an optical SDM transmission line can be a multimode fiber, a multi-core optical fiber, or a fiber-optic cable comprising a plurality of bundled optical fibers.

In some embodiments, SDM input port 102 and SDM output port 162 may be designed for being connected to different types of transmission lines. For example, in one embodiment, SDM input port 102 may be designed for being connected to a multimode fiber, while SDM output port 162 may be designed for being connected to a fiber-optic cable or to a multi-core optical fiber. As another example, in an alternative embodiment, SDM input port 102 may be designed for being connected to a multi-core optical fiber, while SDM output port 162 may be designed for being connected to a fiber-optic cable or to a multimode fiber. As yet another example, in yet another alternative embodiment, SDM input port 102 may be designed for being connected to a fiber-optic cable, while SDM output port 162 may be designed for being connected to a multi-core optical fiber or to a multimode optical fiber.

Optical amplifier 100 performs optical signal amplification using a doped multi-core optical fiber 140. In one embodiment, multi-core optical fiber 140 comprises a plurality of doped cylindrical optical waveguide cores surrounded by a first (e.g., inner) cylindrical cladding. The first cylindrical cladding is further surrounded by a second (e.g., outer) cylindrical cladding. The refractive indices of the optical waveguide cores and the first and second claddings satisfy the following condition:

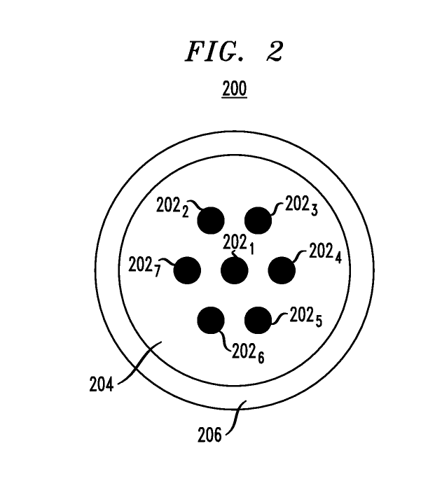

n_{c}>n₁>n₂ (1)

where n_{c} is the refractive index of the material of the optical waveguide cores; n₁ is the refractive index of the material of the first optical cladding; and n₂ is the refractive index of the material of the second optical cladding. Due to this condition and the spacings between the various optical waveguide cores and between the optical waveguide cores and the boundaries of the optical claddings, multi-core optical fiber 140 has (i) a first set of guided modes, wherein each mode substantially is a guided mode of a respective one of the optical waveguide cores, and (ii) a second set of guided modes, wherein each mode substantially is a guided mode of the first cladding. An example embodiment of multi-core optical fiber 140 is described in more detail below in reference to FIG. 2.

Optical amplifier 100 has a pump laser 130 configured to apply optical-pump energy to multi-core optical fiber 140, e.g., by illuminating the terminus of the first cladding on a first end face 138 of the multi-core optical fiber. Due to the condition expressed by Eq. (1), the second cladding of multi-core optical fiber 140 may cause the optical-pump energy to be guided along the length of the first cladding while part of said guided optical-pump energy is transferred into the optical waveguide cores. The optical-pump energy transferred into the optical waveguide cores may provide some of the energy source for optical signal amplification therein, e.g., via stimulated emission or stimulated Raman scattering. In one embodiment, an optional pump-stop filter 146 can be used to block further downstream propagation of the residual optical-pump energy (if any) exiting a second end face 142 of multi-core optical fiber 140. Pump-stop filter 146 however, typically should not substantially attenuate the amplified optical signals that exit multi-core optical fiber 140 so that those signals pass and will propagate toward the downstream portion of optical amplifier 100.

Optical amplifier 100 also may include a free-space isolator 120, 150 at one or both ends of multi-core optical fiber 140. An optional additional free-space isolator (not explicitly shown in FIG. 1) can be placed between pump laser 130 and an optical beam combiner (e.g., a dichroic mirror) 134. Typically, free-space isolators, also known as Faraday optical isolators, are implemented as magneto-optic devices that preferentially transmit light along a single direction, thereby shielding the upstream optics from back reflections. Back reflections may be detrimental because they can create instabilities in light sources and increase the level of optical noise. In some cases, intense back-reflected light can even permanently damage some optical components.

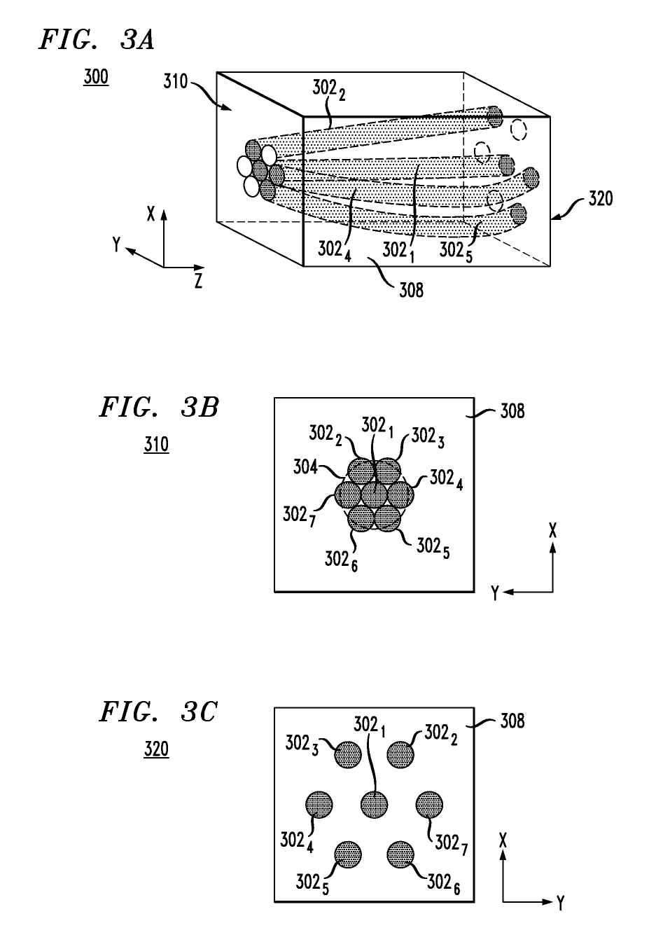

The incoming optical signals received through SDM input port 102 or different portions of the incoming optical signals received through SDM input port 102 are spatially rearranged using an optical coupler 110 to generate a plurality of spatially rearranged optical signals 112. Optical signals 112 are then coupled into multi-core optical fiber 140 such that each of optical signals 112 is coupled into a respective one of the optical waveguide cores in multi-core optical fiber 140. When the first cladding of multi-core optical fiber 140 is optically pumped by pump laser 130, optical signals 112 are optically amplified in the respective optical waveguide cores, e.g., as described above, to generate a plurality of amplified optical signals 152. An optical coupler 160 then spatially rearranges amplified optical signals 152 to generate outgoing optical signals that exit optical amplifier 100 through SDM output port 162. An example embodiment of an optical coupler that can be used as optical coupler 110 and/or optical coupler 160 is described in more detail below in reference to FIGS. 3A-3C.

FIG. 2 shows a cross-sectional view of a multi-core optical fiber 200 that can be used as multi-core optical fiber 140 according to an embodiment of the disclosure. Illustratively, multi-core optical fiber 200 is shown as having seven doped optical waveguide cores 202₁-202₇. Doped optical waveguide core 202₁ is located substantially on the center axis of multi-core optical fiber 200. Doped optical waveguide cores 202₂-202₇ are located at the apices of a hexagon centered on the center axis of multi-core optical fiber 200. One of ordinary skill in the art will understand that other lateral spatial arrangements of the doped optical waveguide cores are also possible. For example, another arrangement may have a number of optical waveguide cores that is different from seven and/or have the doped optical waveguide cores arranged in a geometric pattern that is different from a centered hexagon.

Doped optical waveguide cores 202₁-202₇ are surrounded by an inner cladding 204. Inner cladding 204 may be further surrounded by an outer cladding 206. The refractive indices of doped optical waveguide cores 202₁-202₇, inner cladding 204, and outer cladding 206 satisfy the condition expressed by Eq. (1).

FIGS. 3A-3C show a three-dimensional optical waveguide device 300 that can be used as optical coupler 110 or 160 according to an embodiment of the disclosure. More specifically, FIG. 3A shows a three-dimensional view of optical waveguide device 300. FIG. 3B shows a first end view of three-dimensional optical waveguide device 300 looking at an end face 310 thereof. FIG. 3C shows a second end view of three-dimensional optical waveguide device 300 looking at an end face 320 thereof.

Three-dimensional optical waveguide device 300 comprises a three-dimensional (3D) monolithic structure having multiple optical waveguide cores designed to provide optical end-coupling between (i) multi-core optical fiber 200 (see FIG. 2) and (ii) a multimode optical fiber connected to SDM input port 102 or SDM output port 162 (see FIG. 1). When three-dimensional optical waveguide device 300 operates as optical coupler 110 (i.e., is configured between SDM input port 102 and multi-core optical fiber 140, FIG. 1), the optical signals flow from end face 310 to end face 320. When optical coupler 300 operates as optical coupler 160 (i.e., is configured between SDM output port 162 and multi-core optical fiber 140, FIG. 1), the optical signals flow from end face 320 to end face 310.

Referring to FIG. 3A, three-dimensional optical waveguide device 300 comprises a block 308 of an optical cladding material that surrounds seven optical waveguide cores 302₁-302₇. Each of optical waveguide cores 302₁-302₇ has an approximately circular cross-section in any plane parallel to the XY coordinate plane. Optical waveguide cores 302₁-302₇ are packed relatively closely together at end face 310 (also see FIG. 3B). The separation between optical waveguide cores 302₁-302₇ gradually (e.g., adiabatically) increases along the Z-coordinate axis between end faces 310 and 320, e.g., as indicated in FIG. 3A. Cores 302₁-302₇ are separated from one another by relatively large distances at end face 320 (also see FIG. 3C). Note that, for clarity, only optical waveguide cores 302₁, 302₂, 302₄, and 302₅ are shown within the body of optical cladding block 308 in the see-through view shown in FIG. 3A, while optical waveguide cores 302₃, 302₆, and 302₇ are not explicitly shown therein.

Referring to FIG. 3B, to couple light from an input multimode fiber connected to SDM input port 102 into optical waveguide cores 302₁-302₇ of three-dimensional optical waveguide device 300, optical amplifier 100 employs a first set of imaging optics (not explicitly shown in FIG. 1) configured to image the end face of the input multimode fiber onto end face 310, e.g., such that the optical waveguide core of the input multimode optical fiber forms an image on end face 310 indicated in FIG. 3B by a dashed circle 304. The diameters of optical waveguide cores 302₁-302₇ and the magnification/demagnification of the imaging optics may be selected such that the coupling losses are kept to a relatively low (e.g., close to a minimum possible) value. The gradual increase in the separation between optical waveguide cores 302₁-302₇ within the body of cladding block 308 may ensure that further optical losses within the cladding block, e.g., through radiation modes of the individual optical waveguide cores, are relatively low. As a result, most of the light coupled into optical waveguide cores 302₁-302₇ at end face 310 may be guided by the optical waveguide cores and exit three-dimensional optical waveguide device 300 through end face 320.

In reference to both FIGS. 2 and 3C, the geometric arrangement of optical waveguide cores 302₁-302₇ at end face 320 of three-dimensional optical waveguide device 300 may substantially match the geometric arrangement of doped optical waveguide cores 202₁-202₇ at the corresponding end face of multi-core optical fiber 200. This substantial geometric match may enable optical amplifier 100 to use a second set of imaging optics (not explicitly shown in FIG. 1) to image end face 320 onto the corresponding end face of multi-core optical fiber 200, e.g., such that each of optical waveguide cores 302₁-302₇ (FIG. 3C) is imaged onto a respective one of doped optical waveguide cores 202₁-202₇ (FIG. 2). As a result, the light leaving optical waveguide cores 302₁-302₇ through end face 320 can be efficiently transferred into doped optical waveguide cores 202₁-202₇ for optical amplification therein.

At the back end of multi-core optical fiber 200, two additional sets of imaging optics (not explicitly shown in FIG. 1) and another instance (physical copy) of three-dimensional optical waveguide device 300 can similarly be used to couple amplified optical signals generated by multi-core optical fiber 200 into an output multimode fiber connected to SDM output port 162 (FIG. 1). More specifically, a first additional set of imaging optics can be used to image the back-end face of multi-core optical fiber 200 onto end face 320 of three-dimensional optical waveguide device 300 configured as optical coupler 160 (FIG. 1). This imaging will cause efficient transfer of light from doped optical waveguide cores 202₁-202₇ of multi-core optical fiber 200 into optical waveguide cores 302₁-302₇ of three-dimensional optical waveguide device 300. A second additional set of imaging optics can then be used to image end face 310 of three-dimensional optical waveguide device 300 configured as optical coupler 160 onto the end face of the output multimode fiber connected to SDM output port 162, e.g., in the manner indicated by dashed circle 304 in FIG. 3B. This imaging will cause efficient transfer of light from optical waveguide cores 302₁-302₇ of three-dimensional optical waveguide device 300 into the optical waveguide core of the output multimode optical fiber.

The optical couplers 110 and 160 may or may not be nominally identical to one another, as in the above-described example. More specifically, optical coupler 110 can be designed to provide efficient light transfer from the specific input multimode optical fiber, multi-core optical fiber, or fiber-optic cable used at SDM input port 102, through a respective set of free-space imaging optics, and into the doped optical waveguide cores of the specific embodiment of multi-core optical fiber 140 in optical amplifier 100. Similarly, optical coupler 160 can be designed to provide efficient light transfer from the doped optical waveguide cores of the specific embodiment of multi-core optical fiber 140, through a respective set of free-space imaging optics, and into the specific output multimode optical fiber, multi-core optical fiber, or fiber-optic cable used at SDM output port 162. As such, alternative embodiments of optical couplers 110 and 160 used in alternative embodiments of optical amplifier 100 may be different from three-dimensional optical waveguide device 300 (FIG. 3) and/or from each other. Three-dimensional optical waveguide devices for optical couplers 110 and 160 can be manufactured, e.g., as described in U.S. Pat. No. 8,270,788 and/or U.S. Patent Application Publication No. 2012/0039567, both of which are incorporated herein by reference in their entirety. Suitable 3D multi-optical-core waveguide devices for optical couplers 110 and 160 may also be commercially obtained, e.g., from Optoscribe Ltd. of Livingston, West Lothian, Scotland, UK.

Alternative geometric patterns in which optical waveguide cores may be arranged at end face 310 can be selected, e.g., from a set including but not limited to: (i) a honeycomb-like pattern; (ii) a linear array of optical waveguide cores; (iii) a rectangular array of optical waveguide cores; (iv) an array of optical waveguide cores arranged on a circle; (v) an array of optical waveguide cores arranged on two or more concentric circles; and (vi) a non-symmetric or irregular pattern. Alternative geometric patterns in which optical waveguide cores may be arranged at end face 320 can similarly be selected from these and other suitable alternatives. Within the same three-dimensional optical waveguide device 300, the respective arrangements of optical waveguide cores at end faces 310 and 320 may differ from one another in at least one of: (i) the separation distance between at least two of the optical waveguide cores, (ii) the diameter of at least one optical waveguide core, and (iii) the geometric patterns in which the optical waveguide cores are arranged at the end faces. In some embodiments, the number of optical waveguide cores at end face 310 may differ from the number of optical waveguide cores at end face 320. In such embodiments, some of optical waveguide cores have a branched topology, wherein an optical waveguide core is split into two or more optical waveguide cores inside optical cladding block 308.

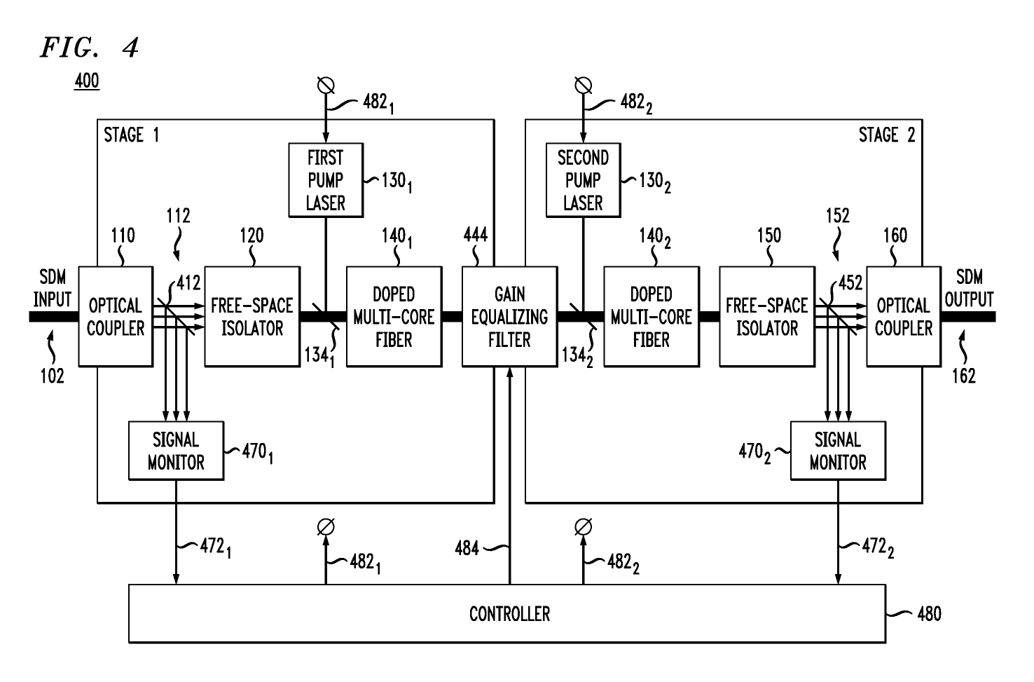

FIG. 4 shows a block diagram of an optical amplifier 400 according to another embodiment of the disclosure. Optical amplifier 400 differs from optical amplifier 100 (FIG. 1) in that it is a two-stage amplifier, with the two stages being labeled in FIG. 4 as Stage 1 and Stage 2, respectively. However, optical amplifier 400 employs some of the same components as optical amplifier 100, as indicated by the common numerical labels used in both FIGS. 1 and 4. The description of these (reused) components is not repeated here. Instead, the description of optical amplifier 400 that follows outlines the differences between optical amplifiers 400 and 100 and focuses on the additional components present in optical amplifier 400 but not in optical amplifier 100.

Each of Stages 1 and 2 includes a respective optical signal monitor 470. Optical signal monitor 470₁ in Stage 1 is configured to receive (attenuated) copies of spatially rearranged optical signals 112 from an optical splitter 412 located between optical coupler 110 and free-space isolator 120. In an example embodiment, optical splitter 412 has a signal-splitting ratio of about 1% to about 99%, which causes about 1% of the light from each of optical signals 112 to be tapped off and redirected toward optical signal monitor 470₁. Optical signal monitor 470₂ in Stage 2 is configured to receive (attenuated) copies of amplified optical signals 152 from an optical splitter 452 located between free-space isolator 150 and optical coupler 160. In an example embodiment, optical splitter 452 is similar to optical splitter 412 in terms of its signal-splitting, which causes about 1% of the light from each of optical signals 152 to be tapped off and redirected toward optical signal monitor 470₂.

By processing the light received from optical splitter 412, optical signal monitor 470₁ measures the total signal intensity and optionally the spectrum of each of optical signals 112. The measurement results are then provided, via an electrical signal 472₁, to a controller 480. By similarly processing the light received from optical splitter 452, optical signal monitor 470₂ measures the total signal intensity and optionally the spectrum of each of optical signals 152. Optical signal monitor 470₂ similarly provides the measurement results to controller 480, via an electrical signal 472₂.

In an example embodiment, an optical signal monitor 470 comprises means for spectrally dispersing the received light (e.g., a diffraction grating) and an array of photo-detectors (e.g., a charge-coupled device, CCD) configured to measure the intensity of the spectrally dispersed light in a wavelength-sensitive manner. Different surface areas of the photo-detector array can be used for receiving and measuring different signals, as known in the art. Such a configuration enables optical signal monitor 470 to perform the above-indicated spectral and intensity measurements in a signal-specific manner.

Based on the measurement results received from optical signal monitors 470₁ and 470₂, controller 480 can determine and monitor over time the effective optical gain in optical amplifier 400 in a spatial-channel- and wavelength-specific manner. As used herein, the term “spatial channel” refers to a series of optical elements in optical amplifier 400 optically coupled to one another and operating to transform a respective one of optical signals 112 into a respective one of amplified optical signals 152. An example spatial channel in optical amplifier 400 comprises (i) a doped optical waveguide core of multi-core optical fiber 140₁, (ii) a corresponding sub-channel of a gain-equalizing filter 444, and (iii) a corresponding doped optical waveguide core of multi-core optical fiber 140₂.

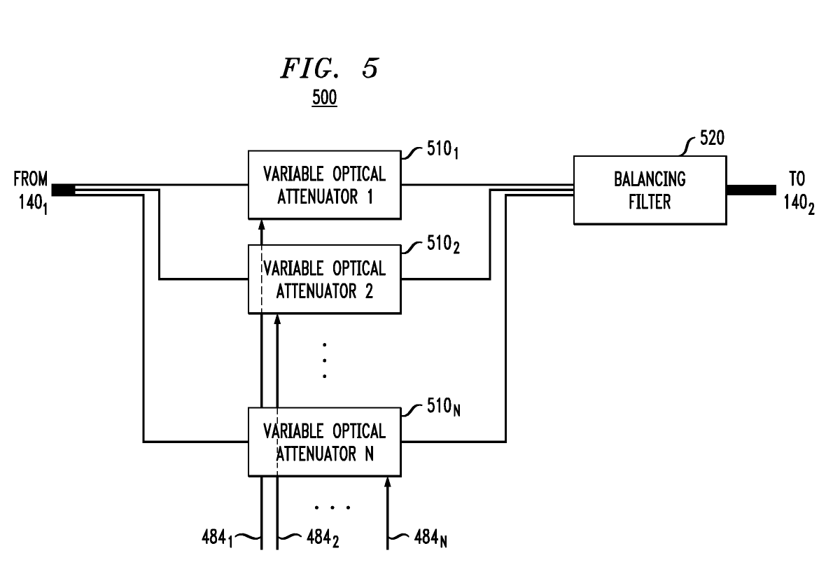

Controller 480 can use control signals 482₁, 482₂, and 484, e.g., to adjust the respective optical gains of different spatial channels of optical amplifier 400 as appropriate or necessary. For example, in response to control signal 482₁, pump laser 130₁ may change the output wavelength and/or intensity of the pump beam applied to the inner cladding of doped multi-core optical fiber 140₁. In response to control signal 482₂, pump laser 130₂ may similarly change the output wavelength and/or intensity of the pump beam applied to the inner cladding of doped multi-core optical fiber 140₂. Note that, during at least some time periods, pump lasers 130₁ and 130₂ may output pump beams having different respective wavelengths. In response to control signal 484, gain-equalizing filter 444 may change signal attenuation in its sub-channels, e.g., as described below in reference to FIG. 5. Thus, using control signals 482₁, 482₂, and 484, controller 480 can adjust the operating parameters of pump lasers 130₁ and 130₂ and gain-equalizing filter 444 to achieve and maintain the desired optical-gain characteristics for optical amplifier 400.

In some embodiments, gain-equalizing filter 444 is configured to individually control gain equalization for each spatial and/or wavelength channel. For example, the gain correction or equalization imposed by gain-equalizing filter 444 as a function of wavelength may depend on the signal's input power and/or be directed at correcting the effects of possible small variations between the characteristics of different doped optical waveguide cores 202 (FIG. 2).

FIG. 5 shows a block diagram of a gain-equalizing filter 500 that can be used as gain-equalizing filter 444 according to an embodiment of the disclosure. Gain-equalizing filter 500 is illustratively shown as being connected between multi-core optical fibers 140₁ and 140₂ (FIG. 4) and configured to receive control signal 484 (also see FIG. 4). One of ordinary skill in the art will understand that gain-equalizing filter 500 can also be used in other alternative configurations.

Gain-equalizing filter 500 comprises a plurality of variable optical attenuators 510₁-510_{N}. For example, an embodiment of gain-equalizing filter 500 suitable for being connected between two multi-core optical fibers 200 (FIG. 2) corresponds to N=6 or 7. The number N may be the number of spatial channels in optical amplifier 400 or may be the number of spatial channels in optical amplifier 400 minus one. Thus, N can be any positive integer greater than one in various embodiments. The attenuation in each of optical attenuators 510₁-510_{N} can be changed, e.g., using a respective one of control signals 484₁-484_{N} generated by controller 480 based on electrical signals 472₁ and 472₂ (FIG. 4).

In operation, each of optical attenuators 510₁-510_{N} receives a respective optical signal from a respective doped optical waveguide core of multi-core optical fiber 140₁. In response to a respective one of control signals 484₁-484_{N}, each of optical attenuators 510₁-510_{N} applies a respective desired degree of attenuation to the received optical signal to generate a respective attenuated optical signal. The signal attenuation imposed in each of optical attenuators 510₁-510_{N} may be substantially wavelength-independent so that all wavelengths in the received optical signal are attenuated in optical attenuator 510 by substantially the same dB value.

Gain-equalizing filter 500 may further comprise a wavelength-balancing filter 520 configured to receive the attenuated optical signals from optical attenuators 510₁-510_{N}, filter these signals, and couple each of the resulting filtered optical signals into a respective doped optical waveguide core of multi-core optical fiber 140₂. Unlike optical attenuators 510₁-510_{N}, wavelength-balancing filter 520 filters the received optical signals in a wavelength-dependent manner. One example spectral transfer function may cause wavelength-balancing filter 520 to impose greater attenuation on shorter wavelengths, e.g., when optical amplifier 400 needs to provide higher optical gain for longer wavelengths. An alternative spectral transfer function may cause wavelength-balancing filter 520 to impose greater attenuation on longer wavelengths, e.g., when optical amplifier 400 needs to provide higher optical gain for shorter wavelengths. The wavelength-balancing filter 520 may apply a suitable spectral transfer function to cause the optical gain of optical amplifier 400 to exhibit desired spectral characteristics. For example, one possible desired spectral characteristic might be a flat (constant, wavelength-independent) optical gain. An alternative desired spectral characteristic might be an optical gain that gradually increases with wavelength. Yet another alternative desired spectral characteristic might be an optical gain that gradually decreases with wavelength. In an example embodiment, wavelength-balancing filter 520 can employ free-space optical elements, such as lenses and filter plates.

In an alternative embodiment, each optical attenuator 510 can be an attenuator that can provide the attenuation in a wavelength-dependent manner and is configurable to set and/or change the imposed attenuation for each wavelength individually. In such an embodiment, wavelength-balancing filter 520 is optional and can be removed from gain-equalizing filter 500.

According to an embodiment disclosed above in reference to FIGS. 1-5, provided is an optical amplifier (e.g., 100, FIG. 1; 400, FIG. 4) suitable for amplifying space-division multiplexed signals, the optical amplifier comprising: an input port (e.g., 102, FIG. 1) configured to end-connect to a first optical fiber transmission line; an output port (e.g., 162, FIG. 1) configured to end-connect to a second optical fiber transmission line; a first doped multi-core optical fiber (e.g., 140, FIG. 1) having a first plurality of optical waveguide cores (e.g., 202, FIG. 2), each configured to amplify, using a first optical pump beam, a respective portion (e.g., 112, FIG. 1) of optical power received through the input port to generate a respective amplified portion of the optical power, wherein the first multi-core optical fiber is configured to direct the amplified portions of the optical power generated by different ones of the first plurality of optical waveguide cores toward the output port; and a first optical coupler (e.g., 110, FIG. 1; 300, FIG. 3) coupled between the input port and the first doped multi-core optical fiber. The first optical coupler comprises a second plurality of optical waveguide cores (e.g., 302, FIG. 3), each configured to guide the respective portion (e.g., 112, FIG. 1) of the optical power received through the input port toward the respective one of the first plurality of optical waveguide cores. A spatial arrangement of the second plurality of optical waveguide cores at an input end (e.g., 310, FIG. 3B) of the first optical coupler is different from a spatial arrangement of the second plurality of optical waveguide cores at an output end (e.g., 320, FIG. 3C) of the first optical coupler.

In some embodiments of the above optical amplifier, the first optical fiber transmission line is a multimode fiber, a multi-core optical fiber, or a fiber-optic cable; and the second optical transmission line is a multimode fiber, a multi-core optical fiber, or a fiber-optic cable.

In some embodiments of any of the above optical amplifiers, the first transmission line and the second transmission line are transmission lines of different respective types.

In some embodiments of any of the above optical amplifiers, the optical amplifier further comprises at least one of: an end portion of the first optical fiber transmission line connected to the input port; and an end portion of the second optical fiber transmission line connected to the output port.

In some embodiments of any of the above optical amplifiers, the optical amplifier further comprises a first laser (e.g., 130, FIG. 1) configured to generate the first optical pump beam.

In some embodiments of any of the above optical amplifiers, the spatial arrangement of the second plurality of optical waveguide cores at the input end of the first optical coupler is different from the spatial arrangement of the second plurality of optical waveguide cores at the output end of the first optical coupler in at least one of: a separation distance between at least two of the optical waveguide cores; a diameter of at least one of the optical waveguide cores; respective geometric patterns in which the optical waveguide cores are arranged; and respective total numbers of the optical waveguide cores.

In some embodiments of any of the above optical amplifiers, the optical amplifier further comprises a second optical coupler (e.g., 160, FIG. 1; 300, FIG. 3) coupled between the first doped multi-core optical fiber and the output port. The second optical coupler comprises a third plurality of optical waveguide cores (e.g., 302, FIG. 3), each configured to guide the respective one of the amplified portions (e.g., 152, FIG. 1) of the optical power generated by different ones of the first plurality of optical waveguide cores toward the output port. A spatial arrangement of the third plurality of optical waveguide cores at an input end (e.g., 320, FIG. 3C) of the second optical coupler is different from a spatial arrangement of the third plurality of optical waveguide cores at an output end (e.g., 310, FIG. 3B) of the second optical coupler.

In some embodiments of any of the above optical amplifiers, the spatial arrangement of the third plurality of optical waveguide cores at the input end of the second optical coupler is different from the spatial arrangement of the third plurality of optical waveguide cores at the output end of the second optical coupler in at least one of: a separation distance between at least two of the optical waveguide cores; a diameter of at least one of the optical waveguide cores; respective geometric patterns in which the optical waveguide cores are arranged; and respective total numbers of the optical waveguide cores.

In some embodiments of any of the above optical amplifiers, the first doped multi-core optical fiber comprises (i) a first optical cladding (e.g., 204, FIG. 2) that laterally surrounds the first plurality of optical waveguide cores and (ii) a second optical cladding (e.g., 206, FIG. 2) that laterally surrounds the first optical cladding. The optical amplifier is configured to couple the first optical pump beam into the first optical cladding. The second optical cladding is configured to guide the first optical beam along the first optical cladding to cause optical energy of the first optical beam to be transferred into the first plurality of optical waveguide cores.

In some embodiments of any of the above optical amplifiers, the first optical coupler further comprises a monolithic block (e.g., 308, FIG. 3A) of an optical cladding material that laterally surrounds the second plurality of optical waveguide cores.

In some embodiments of any of the above optical amplifiers, the optical amplifier further comprises a second doped multi-core optical fiber (e.g., 140₂, FIG. 4) having a third plurality of optical waveguide cores (e.g., 202, FIG. 2), each configured to further amplify, using a second optical pump beam, the respective amplified portion of the optical power received from the respective one of the first plurality of optical waveguide cores to generate a respective further-amplified portion of the optical power, wherein the second multi-core optical fiber is configured to direct said further-amplified portions of the optical power generated by different ones of the third plurality of optical waveguide cores toward the output port.

In some embodiments of any of the above optical amplifiers, the optical amplifier further comprises a second optical coupler (e.g., 160, FIG. 4; 300, FIG. 3) coupled between the second doped multi-core optical fiber- and the output port. The second optical coupler comprises a fourth plurality of optical waveguide cores (e.g., 302, FIG. 3), each configured to guide the respective one of the further-amplified portions (e.g., 152, FIG. 4) of the optical power generated by different ones of the third plurality of optical waveguide cores toward the output port. A spatial arrangement of the fourth plurality of optical waveguide cores at an input end (e.g., 320, FIG. 3C) of the second optical coupler is different from a spatial arrangement of the fourth plurality of optical waveguide cores at an output end (e.g., 310, FIG. 3B) of the second optical coupler.

In some embodiments of any of the above optical amplifiers, the optical amplifier further comprises a second laser (e.g., 130₂, FIG. 4) configured to generate the second optical pump beam.

In some embodiments of any of the above optical amplifiers, the second doped multi-core optical fiber comprises (i) a first optical cladding (e.g., 204, FIG. 2) that laterally surrounds the third plurality of optical waveguide cores and (ii) a second optical cladding (e.g., 206, FIG. 2) that laterally surrounds the first optical cladding. The optical amplifier is configured to couple the second optical pump beam into the first optical cladding. The second optical cladding is configured to guide the second optical beam along the first optical cladding to cause optical energy of the second optical beam to be transferred into the third plurality of optical waveguide cores.

In some embodiments of any of the above optical amplifiers, the optical amplifier further comprises: a first optical monitor (e.g., 470₁, FIG. 4) configured to individually measure intensities of the respective portions of the optical power received through the input optical port; a second optical monitor (e.g., 470₂, FIG. 4) configured to individually measure intensities of said further-amplified portions of the optical power generated by the third plurality of optical waveguide cores; a gain-equalizing optical filter (e.g., 444, FIG. 4) coupled between the first doped multi-core optical fiber and the second doped multi-core optical fiber; and a controller (e.g., 480, FIG. 4) configured to receive measurement results (e.g., 472₁ and 472₂, FIG. 4) from the first optical monitor and the second optical monitor and, in response to the received measurement results, to cause the gain-equalizing optical filter to individually change attenuations applied to the amplified portions of the optical power generated by the first plurality of optical waveguide cores.

In some embodiments of any of the above optical amplifiers, the gain-equalizing optical filter comprises: a plurality of variable optical attenuators (e.g., 510, FIG. 5), each configured to attenuate the respective one of the amplified portions of the optical power generated by the first plurality of optical waveguide cores; and a balancing optical filter (e.g., 520, FIG. 5) configured to change spectral composition of the amplified portions of the optical power generated by the first plurality of optical waveguide cores.

In some embodiments of any of the above optical amplifiers, the optical amplifier further comprises: a first laser (e.g., 130₁, FIG. 4) configured to generate the first optical pump beam; and a second laser (e.g., 130₂, FIG. 4) configured to generate the second optical pump beam, wherein the controller is further configured to cause (i) the first laser to change at least one of intensity and spectral composition of the first optical pump beam and (ii) the second laser to change at least one of intensity and spectral composition of the second optical pump beam, in response to the received measurement results.

In some embodiments of any of the above optical amplifiers, the controller is further configured to cause the first optical pump beam and the second optical pump beam to have different spectral compositions, in response to the received measurement results.

In some embodiments of any of the above optical amplifiers, the optical amplifier further comprises: a first set of imaging optics configured to image a proximate end of the first optical transmission line onto the input end of the first optical coupler; and a second set of imaging optics configured to image the output end of the first optical coupler onto an input end of the first doped multi-core optical fiber.

In some embodiments of any of the above optical amplifiers, the spatial arrangement of the second plurality of optical waveguide cores at the output end of the first optical coupler is nominally identical to a spatial arrangement of the first plurality of optical waveguide cores at an input end of the first doped multi-core optical fiber (e.g., as shown in FIGS. 2 and 3C).

According to another embodiment disclosed above in reference to FIGS. 1-5, provided is an optical amplifier (e.g., 100, FIG. 1; 400, FIG. 4) suitable for amplifying space-division multiplexed optical signals, the optical amplifier comprising: an input optical port (e.g., 102, FIG. 1) configured to end-connect to a first optical fiber transmission line; an output optical port (e.g., 162, FIG. 1) configured to end-connect to a second optical fiber transmission line; a first doped multi-core optical fiber (e.g., 140, FIG. 1 or 4) having a first plurality of optical waveguide cores (e.g., 202, FIG. 2), each configured to amplify, using a first optical pump beam, a respective portion (e.g., 112, FIG. 1) of optical power received through the input port to generate a respective amplified portion of the optical power, wherein the first multi-core optical fiber is configured to direct the amplified portions of the optical power generated by different ones of the first plurality of optical waveguide cores toward the output port; and a first optical coupler (e.g., 160, FIG. 1; 300, FIG. 3) coupled between the first doped multi-core optical fiber and the output optical port. The first optical coupler comprises a second plurality of optical waveguide cores (e.g., 302, FIG. 3), each configured to guide the respective one of the amplified portions (e.g., 152, FIG. 1 or 4) of the optical power generated by different ones of the first plurality of optical waveguide cores toward the output port. A spatial arrangement of the second plurality of optical waveguide cores at an input end (e.g., 320, FIG. 3C) of the first optical coupler is different from a spatial arrangement of the second plurality of optical waveguide cores at an output end (e.g., 310, FIG. 3B) of the first optical coupler.

While this invention has been described with reference to illustrative embodiments, this description is not intended to be construed in a limiting sense.

Contra-directional pumping is not limited to Raman optical amplifiers and can be used with other amplifier types when deemed beneficial.

Various modifications of the described embodiments, as well as other embodiments of the invention, which are apparent to persons skilled in the art to which the inventions pertain are deemed to lie within the principle and scope of the invention as expressed in the following claims.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of the inventions may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

The appearances of the phrase “in one embodiment” in various places in the specification are not necessarily all referring to the same embodiment, nor are separate or alternative embodiments necessarily mutually exclusive of other embodiments. The same applies to the term “implementation.”

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The various present inventions may be embodied in other specific apparatus and/or methods. The described embodiments are to be considered in all respects as only illustrative and not restrictive. In particular, the scope of the inventions is indicated by the appended claims rather than by the description and figures herein. All changes that come within the meaning and range of equivalency of the claims are to be embraced within their scope.

The functions of the various elements shown in the figures, including any functional blocks labeled as “processors” or “controllers,” may be provided through the use of dedicated hardware as well as hardware capable of executing software in association with appropriate software. Moreover, explicit use of the term “computer,” “processor,” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional and/or custom, may also be included.

The description and drawings merely illustrate the principles of the inventions. It will thus be appreciated that those of ordinary skill in the art will be able to devise various arrangements that, although not explicitly described or shown herein, embody the principles of the inventions and are included within its spirit and scope. Furthermore, all examples recited herein are principally intended expressly to be only for pedagogical purposes to aid the reader in understanding the principles of the inventions and the concepts contributed by the inventor(s) to furthering the art, and are to be construed as being without limitation to such specifically recited examples and conditions. Moreover, all statements herein reciting principles, aspects, and embodiments of the inventions, as well as specific examples thereof, are intended to encompass equivalents thereof.

What is claimed is:

1. An apparatus comprising:
a first rare-earth doped multi-core optical fiber having a first plurality of optical waveguide cores, each optical waveguide core configured to guide and amplify a respective portion of optical power received through an input end thereof to generate a respective amplified light signal at an output end thereof;
a first three-dimensional optical waveguide device configured to end-couple an input optical fiber transmission line to the input end of the first rare-earth doped multi-core optical fiber; and
a second three-dimensional optical waveguide device configured to end-couple light from the output end of the first rare-earth doped multi-core optical fiber into an output optical fiber transmission line.

2. The apparatus of claim 1, wherein each three-dimensional optical waveguide device has a respective set of optical waveguide cores connecting first and second faces thereof, the optical waveguide cores having different relative spatial patterns on the first and second faces.

3. The apparatus of claim 2, wherein the optical waveguide cores have different relative spacings on the first and second faces.

4. The apparatus of claim 1, further comprising:
a segment of the first optical fiber transmission line, the first optical fiber transmission line being a type of device selected from the group consisting of a multimode fiber, a multi-core fiber, and a fiber-optic cable; and
a segment of the second optical fiber transmission line, the second optical fiber transmission line being a type of device selected from said group.

5. The apparatus of claim 4, wherein the first optical fiber transmission line and the second optical fiber transmission line are selected from different ones of the types of the group.

6. The apparatus of claim 4, wherein each of the first and second optical fiber transmission lines is either a multi-core optical fiber or a fiber-optic cable.

7. The apparatus of claim 1, further comprising a first laser connected to transmit an optical pump beam to first rare-earth doped multi-core optical fiber.

8. The apparatus of claim 1, wherein one of the three-dimensional optical waveguide devices has a characteristic varying between first and second faces thereof, the characteristic being one of:
a separation distance between at least two of the optical waveguide cores therein;
a diameter of at least one of the optical waveguide cores therein; and
a respective lateral geometric pattern in which the optical waveguide cores therein are arranged.

8. The apparatus of claim 1, wherein:
the first rare-earth doped multi-core optical fiber comprises (i) a first optical cladding that laterally surrounds the first plurality of optical waveguide cores and (ii) a solid second optical cladding that laterally surrounds the first cladding and has a lower refractive index than the first optical cladding.

10. The apparatus of claim 1, further comprising a second rare-earth doped multi-core optical fiber having a second plurality of optical waveguide cores, said second rare-earth doped multi-core optical fiber having an input end coupled to the output end of the first rare-earth doped optical fiber and having an output end coupled to the second three-dimensional optical waveguide device, wherein the second three-dimensional optical waveguide device is configured to end-couple light from the output end of the second rare-earth doped multi-core optical fiber into the output optical fiber transmission line.

11. The apparatus of claim 10, further comprising an optical gain filter coupled between the output end of the first rare-earth doped multi-core optical fiber and the input end of the second rare-earth doped multi-core optical fiber.

12. The apparatus of claim 11, further comprising an electronic controller capable of operating said optical gain filter to vary relative optical powers transmitted from the optical waveguide cores of the first rare-earth doped multi-core optical fiber to the optical waveguide cores of the second rare-earth doped multi-core optical fiber.

13. The apparatus of claim 11, wherein:
the first rare-earth doped multi-core optical fiber comprises (i) a respective first optical cladding that laterally surrounds the first plurality of optical waveguide cores and (ii) a respective solid second optical cladding that laterally surrounds the respective first cladding and has a lower refractive index than the respective first optical cladding;
the second doped multi-core optical fiber comprises (i) a respective first optical cladding that laterally surrounds the second plurality of optical waveguide cores and (ii) a respective solid second optical cladding that laterally surrounds the respective first cladding;
a first laser connected to optically pump the first optical cladding of the first rare-earth doped multi-core optical fiber; and
a second laser connected to optically pump the first optical cladding of the second rare-earth doped multi-core optical fiber.

14. The apparatus of claim 11, further comprising:
a first optical monitor configured to individually measure intensities of the respective portions of the optical power received by the first rare-earth doped multi-core optical fiber;
a second optical monitor configured to individually measure intensities of respective amplified portions of optical power generated by the second plurality of optical waveguide cores at the output end of the second rare-earth doped multi-core optical fiber;
an electronic controller configured to receive measurement results from the first optical monitor and the second optical monitor and, in response to the received measurement results, to cause the optical gain filter to individually vary attenuations applied to individual optical beams transmitted from individual optical waveguide cores of the first rare-earth doped multi-core optical fiber to individual optical waveguide cores of the second rare-earth doped multi-core optical fiber.

15. The apparatus of claim 11, wherein the optical gain filter comprises:
a plurality of variable attenuators, each configured to attenuate a respective one of amplified portions of optical power generated by the first plurality of optical waveguide cores between the output end of the first rare-earth doped multi-core optical fiber and the input end of the second rare-earth doped multi-core optical fiber; and
a balancing optical filter configured to change spectral composition of the amplified portions of the optical power generated by the first plurality of optical waveguide cores between the output end of the first rare-earth doped multi-core optical fiber and the input end of the second rare-earth doped multi-core optical fiber.

16. The apparatus of claim 14, further comprising:
a first laser configured to optically pump the first rare-earth doped multi-core optical fiber; and
a second laser configured to optically pump the second rare-earth doped multi-core optical fiber, wherein the electronic controller is further configured to cause (i) the first laser to change at least one of intensity and spectral composition of optical pump light applied to the first rare-earth doped multi-core optical fiber and (ii) the second laser to change at least one of intensity and spectral composition of optical pump light applied to the second rare-earth doped multi-core optical fiber, in response to the received measurement results.

17. The apparatus of claim 16, wherein the electronic controller is further configured to cause the optical pump light applied to the first rare-earth doped multi-core optical fiber and the optical pump light applied to the second rare-earth doped multi-core optical fiber to have different spectral compositions, in response to the received measurement results.

18. The apparatus of claim 1, further comprising:
a first set of imaging optics configured to image a proximate end of the input optical fiber transmission line onto an input face of the first three-dimensional optical waveguide device; and
a second set of imaging optics configured to image an output face of the first three-dimensional optical waveguide device onto the input end of the first rare-earth doped multi-core optical fiber.

19. An apparatus, comprising:
an input port configured to end-connect to a first optical fiber transmission line;
an output port configured to end-connect to a second optical fiber transmission line;
a first doped multi-core optical fiber having a first plurality of optical waveguide cores, each configured to amplify, using a first optical pump beam, a respective portion of optical power received through the input port to generate a respective amplified portion of the optical power, wherein the first doped multi-core optical fiber is configured to direct the amplified portions of the optical power generated by different ones of the first plurality of optical waveguide cores toward the output port; and
a first optical coupler coupled between the input port and the first doped multi-core optical fiber, wherein:
the first optical coupler comprises a second plurality of optical waveguide cores, each configured to guide the respective portion of the optical power received through the input port toward the respective one of the first plurality of optical waveguide cores; and
a spatial arrangement of the second plurality of optical waveguide cores at an input end of the first optical coupler is different from a spatial arrangement of the second plurality of optical waveguide cores at an output end of the first optical coupler.

20. An apparatus comprising:
an input port configured to end-connect to a first optical transmission line;
an output port configured to end-connect to a second optical transmission line;
a first doped multi-core optical fiber having a first plurality of cores, each configured to amplify, using a first optical pump beam, a respective portion of optical power received through the input port to generate a respective amplified portion of the optical power, wherein the first doped multi-core optical fiber is configured to direct the amplified portions of the optical power generated by different ones of the first plurality of cores toward the output port; and
a first optical coupler coupled between the first doped multi-core optical fiber and the output port, wherein:
the first optical coupler comprises a second plurality of cores, each configured to guide the respective one of the amplified portions of the optical power generated by different ones of the first plurality of cores toward the output port; and
a spatial arrangement of the second plurality of cores at an input end of the first optical coupler is different from a spatial arrangement of the second plurality of cores at an output end of the first optical coupler.
